(19) United States
(12) Patent Application Publication
(10) Pub. No.: US 2010/0034145 A1
(43) Pub. Date: Feb. 11, 2010

(54) METHOD FOR RECEIVING PACKET IN MOBILE COMMUNICATION SYSTEM

(75) Inventors: Jae-Heung Kim, Daejeon (KR); Kyoung-Seok Lee, Daejeon (KR); Jung-Im Kim, Daejeon (KR); Byung-Han Ryu, Daejeon (KR); Seung-Chan Bang, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignees: SAMSUNG ELECTRONICS CO., LTD., Suwon-si, Gyeonggi-do (KR); ELECTRONICS AND TELECOMMUNICATIONS RESEARCH INSTIT, DAEJEON (KR)

(21) Appl. No.: 12/528,568

(22) PCT Filed: Mar. 14, 2008
(86) PCT No.: PCT/KR08/01471

§ 371 Date: Aug. 25, 2009

(30) Foreign Application Priority Data
Mar. 15, 2007 (KR) 10-2007-0025374

(51) Int. Cl. H04W 40/00; H04L 12/66

(52) U.S. Cl. 370/328; 370/352

(57) ABSTRACT

Provided is a method of receiving a packet in a mobile communication system. According to a type of service provided in the present invention and activity of packet service, a mobile station operates in an operation level among DRX (discontinuous reception) operation levels that are based on operation parameters of different values and receives a packet. This results in performing efficient power consumption such that it is possible to minimize power consumption.

### TECHNICAL FIELD

The present invention relates to a method for receiving a packet in a mobile communication system. More particularly, the present invention relates to a packet reception method so as to minimize power consumption.

The present invention is supported by the IT R&D program of MIC/IITA [2005-S-404-13, 3G Evolution Wireless Transmission Technology Development].

### BACKGROUND ART

In a prior ACDMA mobile communication system, mobile stations are classified into a connected state and an idle state according to whether or not they are connected with a base station, and perform a discontinuous reception (hereinafter called “DRX”) operation when it is needed for low power consumption. DRX operation is low power consumption operation that repeats a process in which a mobile station operates in a sleeping mode for an interval when maintaining a least control channel with a base station, awakes when the interval has passed, determines whether or not traffic has occurred, performs a reception operation when the traffic has occurred, and goes back to the sleeping mode when it does not occur.

A mobile station in the idle state only performs the DRX operation in a circuit-based mobile communication system. However, in a packet-based mobile communication system, that is, a LTE (long term evolution) system, a mobile station in the idle state as well as a mobile station in the active state performs the DRX operation so as to reduce power consumption during a duration when there is no data according to burst characteristics of packet traffic. More specifically, radio resources for packet data transmission are discontinuously allocated according to burst characteristics of a packet service while an extra predetermined control channel is maintained. The DRX operation for mobile stations in the active state is performed by gating the control channel according to a predetermined type that is determined on the basis of activity.

However, radio resource allocation for packet data transmission as well as a procedure in which the DRX operation is performed to the control channel is needed, and a method for receiving a packet so as to improve the power consumption performance in a packet-based mobile communication system is also needed.

### DISCLOSURE

### Technical Problem

The present invention has been made in an effort to maximize low power consumption performance in a packet-based mobile communication system. In addition, the present invention has been made in an effort to efficiently perform low power consumption.

Further, the present invention has been made in an effort to minimize information transmitted/received between a base station and a mobile station for low power consumption.

### Technical Solution

According to a first aspect of the present invention, a method for a mobile station to receive a packet in a mobile communication system includes: being provided with information on discontinuous reception operation parameters that include reception intervals from a base station; and operating in one level among a first operation level for receiving packet data every first reception interval, a second operation level for receiving packet data every second reception interval that is shorter than the first reception interval, and a continuous reception level for continuously receiving packet data and receiving the packet data.

When the service from the base station is a real-time service, the step of receiving includes operating and receiving the packet data every second reception interval during the second operation level in a first period in which packet data according to the real-time service is provided, and operating in the first operation level and determining whether the packet data is provided every first reception interval during a second period in which the packet data according to the real-time service is not provided.

In addition, the step of receiving includes receiving the packet data while operating in the second operation level during the first period in which the packet data of the real-time service is provided, performing a transition to the continuous reception level when a non-real-time service starts while the mobile station receives packet data in the second operation level, and transiting to the second operation level when the packet data transmission of the non-real-time service is completed while the mobile station receives packet data in the continuous reception level and receives packet data of the real-time service.

According to a second aspect of the present invention, a method for a mobile station to receive a packet in a mobile communication system includes: being provided with information on discontinuous reception parameters including a first reception interval and a second reception interval that is shorter than the first receiving interval from a base station; operating in a second operation level when the real-time service is provided from the base station and receiving the VoIP packet every second receiving interval during a talk spurt period in which the VoIP packet of a real-time service is transmitted; and operating in a first operation level and determining whether the VoIP packet is transmitted every first receiving interval during a silence period in which the VoIP packet of a real-time service is not transmitted.

### ADVANTAGEOUS EFFECTS

According to the present invention, in a mobile communication system for packet transmission, it is possible that DRX operation parameters for low power consumption are differently determined according to a type and QoS (quality of service) of a packet service. As a result, efficient low power consumption is performed, and thereby power consumption is minimized.

In addition, a DRX operation is performed at a level among DRX operation levels based on a different parameter according to activity of packet data in a corresponding service, and then it is possible to perform better low power consumption.

Further, a mobile station performs a DRX level transition itself according to the activity of the packet data without a control message from a base station, and thereby it is possible to minimize information communicated between a mobile station and a base station for level change.

### DESCRIPTION OF DRAWINGS

FIG. 1 shows a configuration diagram of a mobile communication according to an exemplary embodiment of the present invention.

FIG. 2 shows operations states of a mobile station according to the exemplary embodiment of the present invention.

FIG. 3 shows an example that represents DRX operation parameters according to the exemplary embodiment of the present invention.

FIG. 4 shows a flowchart of a packet reception method according to a first exemplary embodiment of the present invention.

FIG. 5 shows a timing diagram of the packet reception method according to the first exemplary embodiment of the present invention.

FIG. 6 is a flowchart of showing an implicit level transition process in the packet reception method according to the first exemplary embodiment of the present invention.

FIG. 7 is a flowchart showing an explicit transition process for changing an explicit level in the packer receiving method according to the first exemplary embodiment of the present invention.

FIG. 8 shows a flowchart of a packet reception method according to a second exemplary embodiment of the present invention.

FIG. 9 shows a timing diagram of the packet reception method according to the second exemplary embodiment of the present invention.

FIG. 10 shows another flowchart of the packet reception method according to the second exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In this specification, a mobile station (MS) may refer to a terminal, a mobile terminal (MT), a subscriber station (SS), a portable subscriber station (PSS), user equipment (UE), or an access terminal (AT). The mobile terminal may include all or part of the functions of the mobile station, the subscriber station, the portable subscriber station, and the user equipment. In this specification, a base station (BS) may refer to an access point (AP), a radio access station (RAS), a node B, a base transceiver station (BTS), or an MMR (mobile multihop relay)-BS. The base station may include all or part of the functions of the access point, the radio access station, the node B, the base transceiver station, and the MMR-BS.

Now, an exemplary embodiment of the present invention will be described in detail with reference to the accompanying drawings.

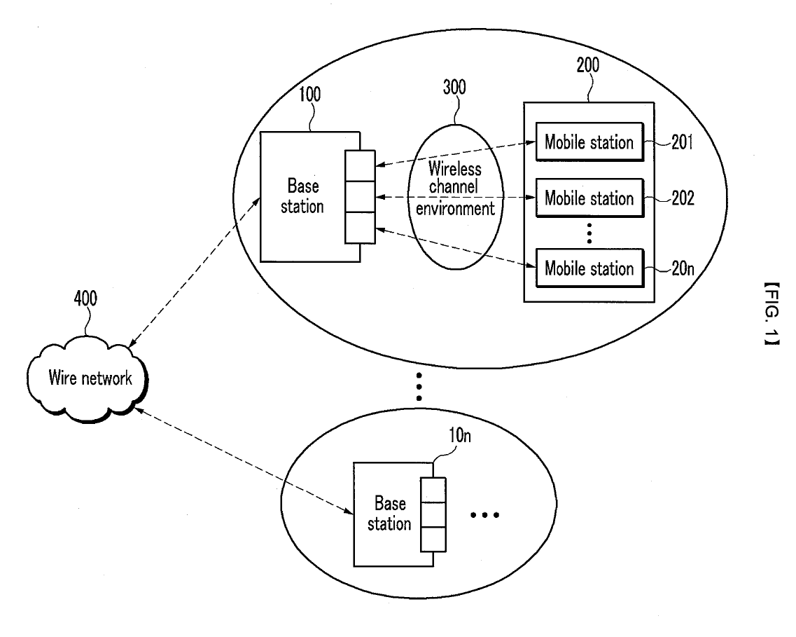

FIG. 1 shows a configuration diagram of a mobile communication system according to an exemplary embodiment of the present invention.

As shown in FIG. 1, in the mobile communication system according to the exemplary embodiment of the present invention, a base station 100 communicates with a plurality of mobile stations (201, 202, • • • 20n, where n is a positive integer) through a radio channel environment 300. For better comprehension and ease of description, a mobile station will be assigned the representative number 200.

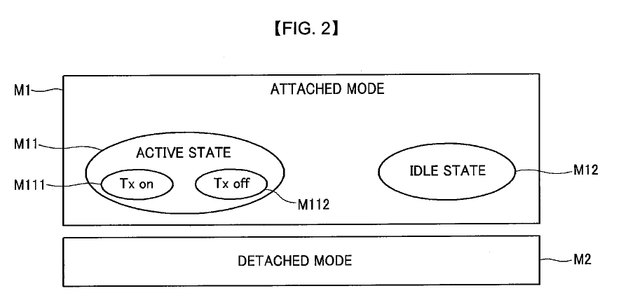

In exemplary embodiments of the present invention, states of the mobile station are defined as below and are managed so as to efficiently use limited radio resource. FIG. 2 shows states of the mobile station according to the exemplary embodiment of the present invention.

As shown in FIG. 2, a state of a mobile station is defined as an attached mode M1 when the mobile station is registered in a base station through a network, and a state of a mobile station is defined as a detached mode M2 when the mobile station is not recognized in a network including a base station or the mobile station is not registered in a network.

Mobile stations in the attached mode are divided into an active state M11 and an idle state M12 according to whether or not a packet service is provided. In the active state, mobile stations may receive allocation of radio resources for receiving/transmitting packet data under control of a scheduler that is disposed in a base station. The mobile station in the active state operates in a transmission mode (Tx on) M111 or a transmission suspension mode (Tx off) M112 according to whether or not radio resources for packet data transmission are allocated. Here, the active state of the mobile station in the attached mode corresponds to an RRC (radio resource control) connected state in an LTE system and the idle state thereof corresponds to an RRC idle (RRC_idle) state in the LTE system.

When there is packet data to be transmitted to the mobile station 200 by the base station 100, the mobile station 200 operates in the transmission mode and receives downlink information in a receiving duration. When there is no packet data, the mobile station 200 operates in the transmission suspension mode and performs a DRX operation in a sleeping duration. The base station and the mobile station may determine parameters for the DRX operation by setting up a radio bearer.

The parameters for the DRX operation vary according to type of packet service and activity of packet data in the exemplary embodiment of the present invention. The packet service is divided into a real-time service (e.g., VoIP (Voice over IP) service) that is characteristic in that packet data is periodically generated, and a non-real-time service (e.g., web browsing) that is characteristic in that the generation of the packet data is aperiodic and unpredictable. The DRX operation parameters are differently determined according to whether the packet service is the real-time service or the non-real-time service, or whether the real-time service is provided along with the non-real-time service. The DRX operation parameters are as follows.

1) DRX-1 interval

2) DRX-2 interval

3) DRX timer-1-4: These are timers for measuring time when the DRX-1 interval or DRX-2 interval is maintained.

The DRX-1 interval and the DRX-2 interval may be generically called “discontinuous reception intervals,” and the DRX-1 interval is longer than the DRX-2 interval. The same DRX-2 interval may be applied to a duration defined by the DRX-1 interval.

In addition, there are increment coefficients that are factors for increasing the DRX-1 interval and the DRX-2 interval in the end of the DRX-1 duration, and maximum DRX-1/DRX-2 intervals and an operation indicator for indicating a transition of the DRX operation. The increment coefficients may be optionally used. That is, the DRX-1 and the DRX-2 intervals are fixed or may be increased up to the maximum DRX-1/DRX-2 intervals according to the increment coefficients.

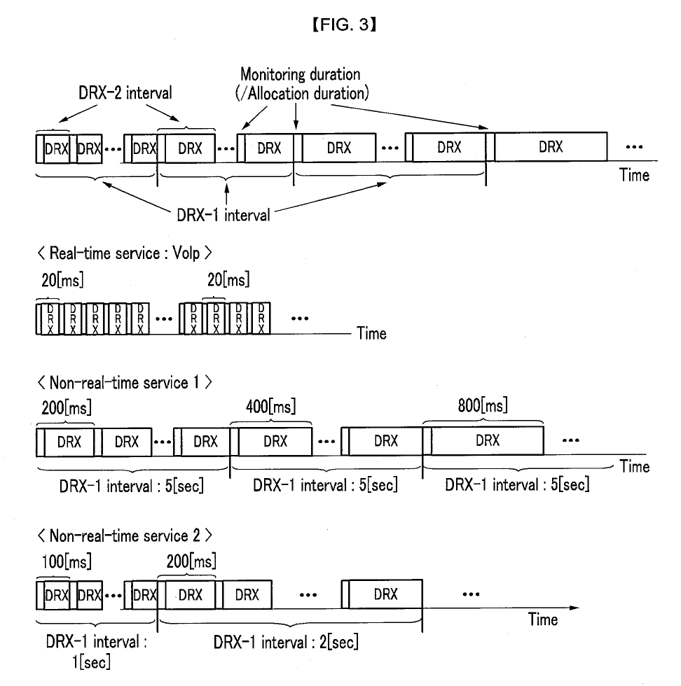

FIG. 3 shows an example of the DRX operation parameters according to the exemplary embodiment of the present invention. The DRX operation parameters may be determined by negotiation between the base station and the mobile station, or values of the DRX intervals may be changed without control signaling.

As shown in FIG. 3, the same DRX-interval is applied during the DRX-1 interval. A value of the DRX-2 interval is also smaller than that of the DRX-1 interval. The values of the DRX-1 interval and the DRX-2 interval may be different according to a type of a packet service.

The DRX operation according to the exemplary embodiment of the present invention is performed in a first operation level (DRX-1 level) or a second operation level (DRX-2 level). Here, the first operation level is an operation in which a mobile station awakes every DRX-1 interval and confirms whether or not to receive packet data, and the second operation level is an operation in which a mobile station awakes every the DRX-2 interval and confirms that the same.

Meanwhile, the base station, as shown in FIG. 2, DRX, informs the generation of downlink traffic in a monitoring section that is disposed at a termination moment of a DRX interval or transmits radio resource allocation information for reporting status or measurement or requesting radio resources through uplink. The mobile station operating in the transmission suspension mode recognizes the presence of downlink traffic generation information transmitted through a downlink traffic notification channel in a monitoring section, and determines whether or not to receive the downlink packet data. In addition, the mobile station recognizes uplink radio resource allocation information transmitted through a downlink control channel and transmits control information such as measurement information or radio resource allocation request through the uplink. When there is no downlink traffic or when packet data to be transmitted through the uplink is not received from an upper layer of a mobile station, the mobile station performs a low power consumption operation during a DRX interval until the next monitoring section. In the low power consumption operation, the mobile station does not receive downlink signals and does not transmit signals through the uplink.

For example, as shown in FIG. 2, when a real-time service, that is, a voice service (VoIP: Voice over IP) is provided, the DRX-2 interval is set as 20 ms, and the increment coefficient is set as “1” regardless of the DRX-1 interval. Therefore, a method that performs a low power consumption operation according to the DRX-2 interval is considered while the change of DRX-interval is restricted in the active state in which the voice service is provided. That is, by fixing and managing the DRX interval in the real-time service, it is possible to reduce overhead caused by control information transmission since radio resource allocation is periodically performed without transmitting an extra control massage (e.g., L1/L2 control signaling) for the radio resource allocation. At the same time, power consumption of a mobile station is reduced while it is possible to achieve QoS of a corresponding service that is needed in the system. Here, the DRX-2 interval may be differently established by mobile stations according to a type of the real-time service and capacity of a mobile station.

Meanwhile, in an Http service (Internet accessing) of a non-real-time service, as shown in FIG. 2, the DRX-1 interval that maintains the DRX-2 interval is set as a multiple of TTI according to statistical characteristics of packet service while considering load state of a base station, and the increment coefficient is set as over “2”. As described above, the DRX intervals vary, and thereby transmission capacity of the system improves. That is, the non-real-time service is not sensitive to delay of packet data and activity of the service is not predicted. Therefore, the DRX-intervals are set to be longer than those of the real-time service according to the load state of the base station, the type of the non-real-time service, and the capacity of the mobile station. The DRX intervals may vary by using the DRX-1 interval and the increment coefficient.

Packet reception methods according to exemplary embodiments of the present invention based on the DRX operation parameters will now be described in detail.

First, a packet reception method according to a first exemplary embodiment of the present invention will be described.

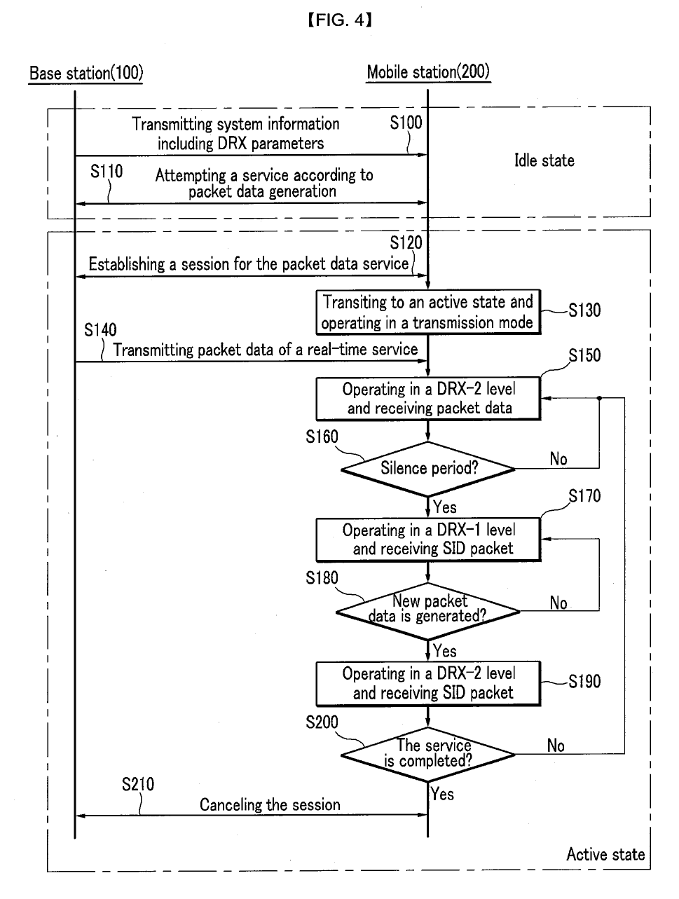

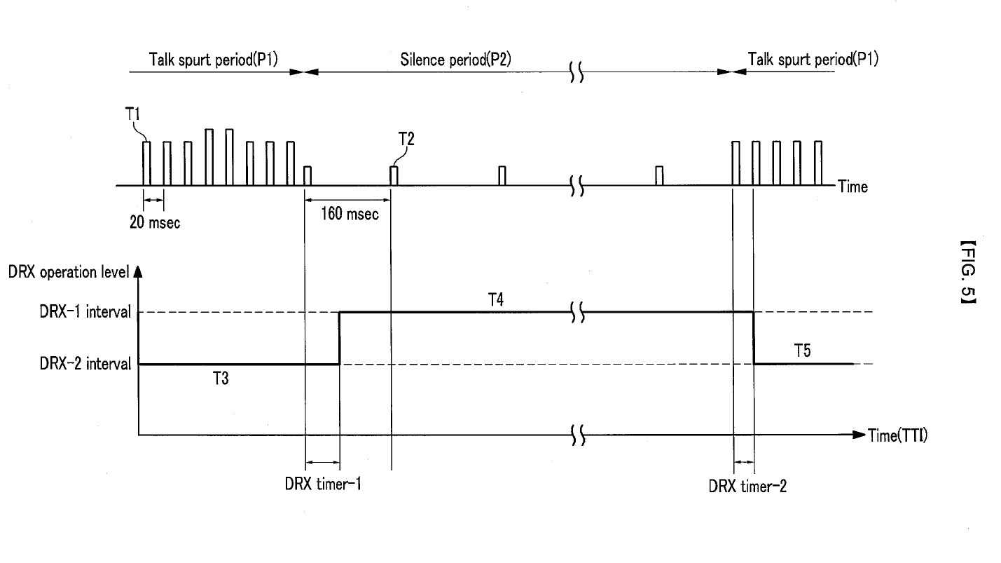

FIG. 4 shows a flowchart of the packet reception method according to the first exemplary embodiment of the present invention, and FIG. 5 shows a timing diagram according to the first exemplary embodiment of the present invention. The first exemplary embodiment of the present invention relates to a case of receiving a packet by performing a DRX operation when a real-time service, for example a VoIP service, is provided.

The VoIP of the voice service is a representative real-time service, and VoIP packets are generated at regular intervals in a talk spurt period in which a user speaks because of having a periodical characteristic. A SID (silence descriptor) packet is periodically generated at intervals, which are longer than the interval at which a VoIP packet is generated in the talk spurt period, in a silence period in which a user does not speak.

The DRX operation parameters for controlling the DRX operation when the VoIP service is provided in the first exemplary embodiment of the present invention are determined as in the following Table 1.

TABLE 1

| Parameter | Value |
|---|---|
| DRX-1 interval | 160 ms |
| DRX-2 interval | 20 ms |
| DRX-1 timer | 40 ms |
| DRX-2 timer | 40 ms |

Here, the DRX timer-1 is a timer for transition from a DRX-2 level to a DRX-1 level, and DRX timer-2 is a timer for transition from the DRX-1 level to the DRX-2 level.

The packet reception method for performing low power consumption when the VoIP service of the real-time service is provided will be described based on the operation parameters according to the first exemplary embodiment of the present invention.

A base station 100 determines the DRX operation parameters for low power consumption, as shown in FIG. 4, and includes information on the determined DRX operation parameters in system information to be transmitted through a broadcasting channel, and transmits the same (S100). The DRX operation parameters included in the system information include a DRX-1 interval, a DRX-2 interval, a DRX timer-1, and a DRX timer-2. Other parameters may also be included therein.

When packet data is generated, the base station 100 attempts to provide a service corresponding to the packet data. Herein the base station 100 attempts to provide the service through phasing. A mobile station 200 receives system information during a phasing monitoring section and then attempts to perform a random access, thereby receiving the packet data of the service (S110).

The base station 100 changes the state of the mobile station 200 into an active state through state transition control, and the mobile station 200 operates in the transmission mode after the transition to the active state. A session determination procedure is performed by negotiation between the mobile station and the base station when the mobile station transits from the idle state to the active state. In order to transmit/receive the packet data, an RRC connection is established by the session determination procedure, and basic parameters of an upper layer for the connection are set up (S120). In this instance, the base station may negotiate with the mobile station for DRX operation parameters while a radio bearer is established, and may further inform the negotiated DRX operation parameters by using an RRC message.

When the VoIP service starts in the transmission mode of the active state through the above described process (T1), the mobile station 200 receives VoIP packet data transmitted from the base station 100 during the talk spurt period P1 (S130-S140). Particularly, the mobile station 200 receives the packet while operating in a DRX-2 level (S150), and more specifically, as shown in FIG. 5, awakes every DRX-2 interval, that is, 20 ms, and receives the VoIP packet, that is, a voice packet (T2).

When entering the silence period P2 in which a user does not speak from the talk spurt period P1, the mobile station 200 transits to the DRX-1 level and performs the DRX operation (S160-S170). More specifically, the mobile station 200 awakes every DRX-2 interval and determines whether or not the voice packet is received during the time determined by the DRX timer-1. If the voice packet is not received even though the time determined by the DRX timer-1 has passed, the mobile station 200 determines that the present period is a silence period P2 and performs the DRX operation according to the DRX-1 interval for the silence period. Then the mobile station 200 awakes every DRX-1 interval and receives the SID packet while determining whether or not the SID packet is received (T4). In this instance, the mobile station 200 may know a section in which the SID packet is generated based on the DRX timer-1.

The transition of the DRX level is performed by an implicit rule or explicit signaling between the base station and the mobile station.

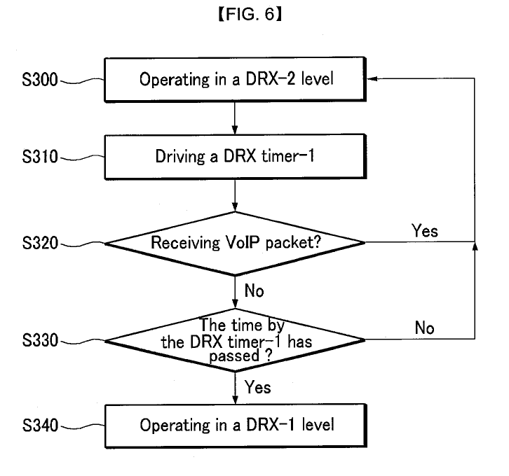

FIG. 6 shows a flowchart of a case in which the level transition is implicitly performed according to the first exemplary embodiment of the present invention.

When the level transition is performed by the implicit rule, as described above, the mobile station 200 individually drives the DRX timer-1 and counts time after entering the silence period P2 in the DRX-2 level (S300-S310). If the packet is not received even though the time determined by the DRX timer-1 as described above has passed, the mobile station 200 transits to the DRX-1 level and performs the DRX operation without a specific command from the base station 100 (S320-S340). In this case, the base station 100 may recognize that the mobile station 200 transits to the DRX-1 level when the packet is not generated even though the time determined by a DRX timer-1 which is driven by the base station is passed.

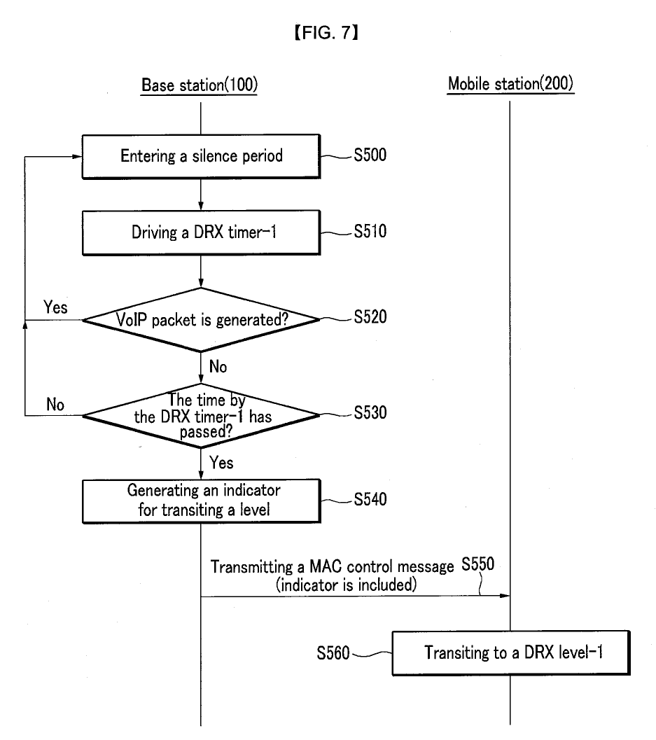

FIG. 7 shows a flowchart of a case in which the level transition is explicitly performed according to the first exemplary embodiment of the present invention.

When the level transition is performed by an explicit rule, the mobile station 200 performs the transition from the DRX-2 level to the DRX-1 level according to a command from the base station 100. To be specific, the base station 100 manages the DRX timer-1, drives it when entering the silence period P2 (S500-S510), determines that the silence period entering is completed when a packet is not generated even though the time determined by the DRX timer-1 has passed, and commands the mobile station 200 to transit to the DRX-1 level (S520-S540). In this case, the base station 100 transmits a MAC (medium access control) control message to the mobile station 200 while including a level transition operation indicator therein (S550). The mobile station 200 performs the transition to the DRX-1 level according to the indicator that is included in the MAC control message (S560). In addition, the level transition operation indicator may be included in scheduling control information and be transmitted to the mobile station 200.

In the level transition as described above, at a point when a last voice packet is transmitted in the talk spurt period, after an ACK (acknowledgement) according to HARQ (hybrid automatic retransmit request) is received, or after the ACK is transmitted, the base station may determine the silence period entering by driving the DRX timer-1. Meanwhile, as described above, in a state in which the mobile station determines whether a packet is received by awaking every DRX-1 interval after the transition from the DRX-2 level to the DRX-1 level, the mobile station 200 drives the DRX timer-2 when entering the talk spurt period (S180) according to generation of a voice packet caused by the speaking of the user's opponent, as shown in FIGS. 4 and 5. In other words, the mobile station 200 that awoke every DRX-1 interval and received the SID packet, as shown in FIG. 5, drives the DRX timer-2 at a point when the voice packet is received.

The mobile station 200 monitors whether or not the voice packet is received during the time determined by the DRX timer-2, determines that the talk spurt period entering is completed, transits to the DRX-2 level, and performs the DRX operation according to the DRX-2 interval (S190).

For the DRX level transition, the mobile station 200 operates according to the DRX-1 interval in the silence period, but monitors whether the voice packet is received during the time determined by the DRX timer-2 after awaking for the reception of the SID packet in the silence period. Therefore, a sleeping duration in the silence period substantially becomes 120 ms (when DRX-1 inter is 160 msec and the DRX timer-2 is 40 ms).

The transition from the DRX-1 level to the DRX-2 level may be performed by an implicit method based on a value of the timer (DRX timer-2) or explicit signaling. To explicitly perform the level transition, the base station 100 manages the DRX timer-2 and drives it. Further, the base station 100 transmits a MAC control message (or scheduling control information) indicating the transition from the silence period to the talk spurt period to the mobile station 200 when a new voice packet is generated. Since a person of ordinary skill in the art can realize the implicit and explicit level transitions using the DRX timer-2 based on the methods of FIG. 6 and FIG. 7, a detailed description thereof is omitted.

If it is possible to determine whether packet data, which is generated in a MAC layer of a base station or a mobile station in a VoIP service, is a SID packet or a voice packet, the DRX level may be transited without setting the DRX timer-1 and the DRX timer-2.

According to the first exemplary embodiment, DRX operations in a duration when packet data is transmitted and a duration when the packet data is not transmitted are differently performed when a real-time service is provided. As a result, the DRX level transition is efficiently performed according to activity of data, and thereby low power consumption performance improves.

Also, despite the fact that there is no control message from a base station, a mobile station individually performs DRX level transition. Therefore, it is possible to minimize control information transmitted/received between the base station and the mobile station for the level transition.

Next, a packet reception method according to a second exemplary embodiment of the present invention will be described.

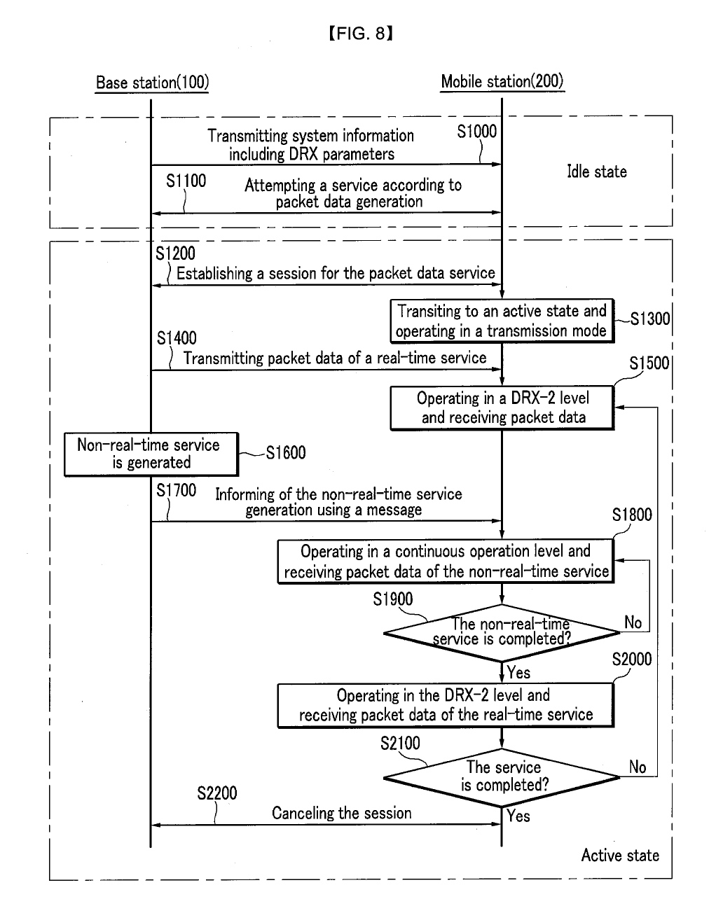

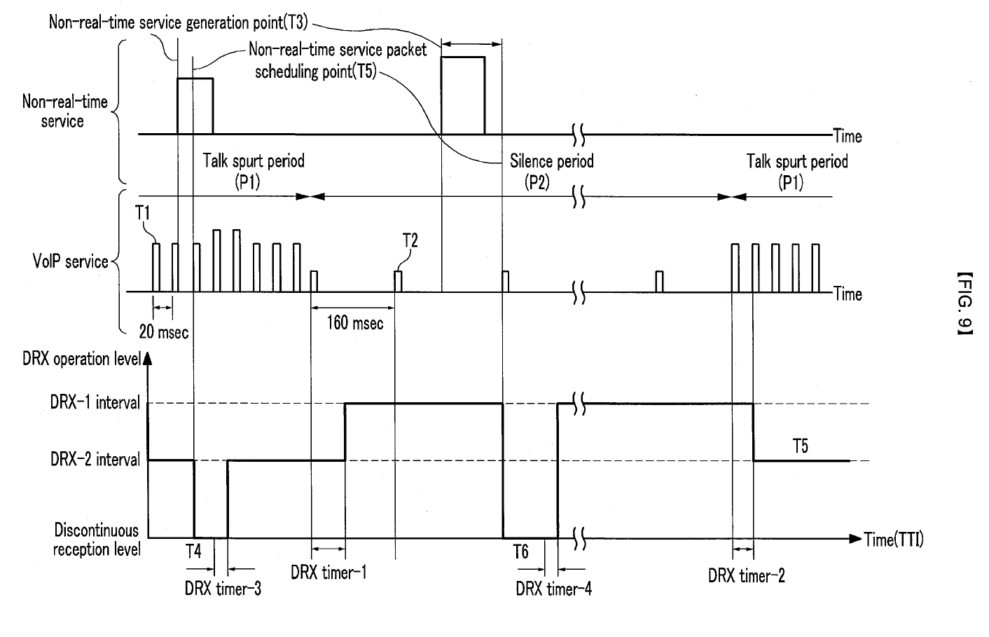

FIG. 8 shows a flowchart of the packet reception method according to the second exemplary embodiment of the present invention, and particularly shows a flowchart of a case in which a non-real-time service starts while a real-time service is provided. FIG. 9 shows a timing diagram for the packet reception according to the second exemplary embodiment of the present invention.

The second exemplary embodiment of the present invention relates to a case in which packet is received by transiting DRX level according to activity of packet data when the non-real-time service is provided along with the real-time service.

DRX operation parameters for control of DRX operation are determined as in the following Table 2 in the second exemplary embodiment of the present invention. When the non-real-time service is provided along with the real-time service, the DRX intervals may be determined by aiming at the real-time service as the first exemplary embodiment.

TABLE 2

| Parameter | Value |
|---|---|
| DRX-1 interval | 160 ms |
| DRX-2 interval | 20 ms |
| DRX-3 timer | 40 ms |
| DRX-4 timer | 40 ms |

Here, the DRX timer-3 is for a transition from a continuous reception level in which packet data is continuously received to a DRX-2 level in which the packet data is discontinuously received. The DRX timer-4 is for a transition from the continuous reception level to a DRX-1 level in which the packet data is discontinuously received. The DRX timer-3 and the DRX timer-4 for the transition from the continuous reception level to the DRX-2 level or the DRX-1 level may use the same values or different values according to a state of a base station, capability of a mobile station, and QoS of a non-real-time service.

In the second exemplary embodiment of the present invention based on the operation parameters, a packet reception method for performing low power consumption when a real-time service is provided along with a non-real-time service will be described. First, for the non-real-time service that starts while the real-time service is provided in a transmission mode of an active state, a packet reception method will be described.

As in the first exemplary embodiment, a mobile station 200 is provided with information on the DRX operation parameters from a base station 100, as shown in FIGS. 8 and 9. When the real-time service, for example VoIP, service starts in the transmission mode of the active state (S1000-S1300), the mobile station 200 awakes and receives a VoIP packet every DRX-2 interval (S1400-S1500). The mobile station 200 confirms allocation of radio resources for the non-real-time service by determining whether a scheduling control information message is transmitted from the base station 100 the moment it receives the VoIP packet according to the DRX-2 interval.

The base station 100 informs the mobile station of the providing of the non-real-time service through a scheduling control information message or a MAC control message when transmitting the packet data of the real-time service at the point of allocating the resource for the real-time service (S1600-S1700).

When receiving the scheduling control information message or the MAC control message for the non-real-time service while operating low power consumption in the DRX-2 level according to the DRX-2 interval, the mobile station 200 recognizes that it should receive the packet data for the non-real-time service regardless of the DRX-2 interval, and transits to the continuous reception level. The mobile station then receives the packet data through a downlink radio resource (S1800).

When receiving the packet data in the continuous reception level by the start of the non-real-time service in a state in which the real-time service is provided, the mobile station 200 transits from the continuous reception level to the DRX-2 level if the packet data transmission of the non-real-time service is completed and receives the packet data of the real-time service (S1900).

To be specific, the base station 100 drives the DRX timer-3 after transmitting all packet data stored in a transmission buffer of the non-real-time service, counts time, and monitors the transmission buffer. If new packet data is not stored in the transmission buffer even though the time determined by the DRX timer-3 has passed, the base station 100 transmits a MAC control message or a L1/L2 control message for indicating a transition to the DRX-2 level to the mobile station 200. Accordingly, the mobile station 200 transits from the continuous reception level to the DRX-2 level when receiving the MAC control message or the L1/L2 control message for indicating the DRX-2 level transition, and performs the low power consumption operation for receiving packet data every DRX-2 interval.

The level transition is performed by an explicit method in which the mobile station 200 performs the level transition according to a command of the base station 100, but it may be performed by an implicit method.

That is, the implicit method is to allow the mobile station 200 to manage and drive the DRX timer-3, and the mobile station 200 performs the transition from the continuous reception level to the DRX-2 level without control of the base station. In this case, the mobile station 200 drives the DRX timer 3 when packet data is not received in the continuous reception level, transits to the DRX-2 level when the packet data is not received even though the time determined by the DRX timer-3 has passed, and performs the low power consumption operation.

Next, for a non-real-time service that starts in a transmission suspension mode of an active mode, a packet reception method will be described.

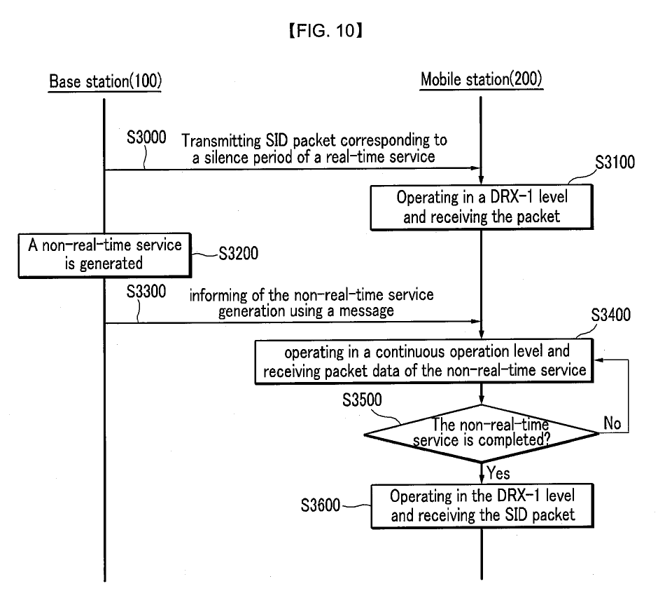

FIG. 10 shows a flowchart of a packet reception method according to a second exemplary embodiment of the present invention, and more particularly a flowchart of a case in which the non-real-time service starts during a silence period.

When a mobile station 200 operates in the silence period according to a DRX-1 level while a real-time service is provided (S3000-S3100), as shown in FIG. 10, the base station 100 informs the mobile station 200 of the starting of the non-real-time service through a scheduling control message or a MAC control message at the point of transmitting a SID packet according to a DRX-1 interval when packet data to be transmitted to the mobile station 200 is generated (S3200-S3300).

The mobile station performing low power consumption according to the DRX-1 interval in the silence period recognizes that it should receive the packet data of the non-real-time service regardless of the DRX-1 interval when receiving the scheduling control message or the MAC control message for the non-real-time service, and transits to a continuous reception level. The mobile station then receives the packet data through a downlink radio resource (S3400).

As described above, the mobile station 200 operates from the continuous reception level to the DRX-1 level when the packet data transmission of the non-real-time service is completed in a state of receiving the packet data after the transition from the DRX-1 level to the continuous reception level (S3500-S3600).

Specifically, the base station 100 drives a DRX timer 4 after transmitting all packet data and then commands the mobile station 200 to transit to the DRX-2 level by transmitting a MAC control message or an L1/L2 control message to the mobile station 200 when new packet data is not generated even though the time determined by the DRX timer-4 has passed. Also, according to an implicit method, the mobile station 200 manages a DRX timer-4 itself and operates in the DRX-1 level when the time determined by the DRX timer-4 has passed.

Meanwhile, in the continuous reception level, when the base station informs that the mobile station should receive not a SID packet but a VoIP packet according to the real-time service or when the mobile station recognizes it itself, the mobile station transits not to the DRX-1 level but to the DRX-2 level in the continuous reception level.

According to the second exemplary embodiment, when different services are provided, the DRX level transition is also efficiently performed based on activity of a data packet, and thereby low power consumption performance improves. In addition, a mobile station individually performs the DRX level transition according to the activity of a packet without a control message from a base station, and it is therefore possible to reduce control information transmitted/received between the mobile station and the base station for the DRX level transition.

Meanwhile, when a real-time service is provided along with a non-real-time service, since the DRX operation parameters are determined based on the real-time service, there may be a time difference between the point of the non-real-time service generation and the point of the non-real-time service packet transmission. In this case, it is possible to prevent the time difference by changing values of the timers or using an extra timer.

In the exemplary embodiments of the present invention, when the DRX level transition is performed by explicit signaling (e.g., a MAC control message) between a base station and a mobile station, the base station manages and drives the timers (DRX timer-1-4) according to the exemplary embodiments. However, when the DRX level transition is implicitly performed without a signaling procedure between the base station and the mobile station, the mobile station 200 manages and drives each timer. The base station may also manage and drive the timers according to need, and the process for transiting the level and changing the DRX operation parameters in the base station may therefore coincide with that in the mobile station.

Further, when only a non-real-time service is provided, the DRX operation parameters may be determined based on a state of the base station, the capability of the mobile station, and QoS of the non-real-time service. In this case, the DRX-1 interval and the DRX-2 interval may be determined as a relatively large value in comparison with that in a real-time service.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for a mobile station to receive a packet in a mobile communication system, the method comprising:
being provided with information on discontinuous reception operation parameters that include reception intervals from a base station; and
operating in one level among a first operation level for receiving packet data every first reception interval, a second operation level for receiving packet data every second reception interval that is shorter than the first reception interval, and a continuous reception level for continuously receiving packet data, and receiving the packet data.

2. The method of claim 1, wherein the mobile station selects one from among the first operation level, the second operation level, and the continuous reception level according to activity of a service to be provided.

3. The method of claim 1, wherein when the service from the base station is a real-time service, the step of receiving comprises:
operating in the second operation level and receiving the packet data every second reception interval during a first period in which packet data according to the real-time service is provided; and
operating in the first operation level and determining whether the packet data is provided every first reception interval during a second period in which the packet data according to the real-time service is not provided.

4. The method of claim 3, further comprising:
performing a transition from the second operation level to the first operation level when entering from the first period to the second period; and
performing a transition from the first operation level to the second operation level when entering from the second period to the first period.

5. The method of claim 1, wherein the step of receiving comprises:
receiving the packet data while operating in the second operation level during the first period in which the packet data of the real-time service is provided;
performing a transition to the continuous reception level when a non-real-time service starts while the mobile station receives packet data in the second operation level; and
transiting to the second operation level when the packet data transmission of the non-real-time service is completed while the mobile station receives packet data in the continuous reception level, and receiving packet data of the real-time service.

6. The method of claim 5, further comprising:
operating in the first operation level and determining whether the packet data is received every first receiving interval during the second period in which packet data of the real-time service is not transmitted;
transiting to the continuous reception level when a non-real-time service is generated while operating in the first operation level; and
transiting to the first operation level and determining whether packet data of a real-time service is received when the packet data transmission of the non-real-time service is completed while receiving the packet data in the continuous reception level.

7. The method of claim 4, wherein the steps of transiting performs the level transition according to an implicit process regardless of control of a base station.

8. The method of claim 4, wherein the steps of transiting performs the level transition according to an explicit process that is based on a message including a level transition indicator from a base station.

9. A method for a mobile station to receive a packet in a mobile communication system, the method comprising:
being provided with information on discontinuous reception parameters including a first reception interval and a second reception interval that is shorter than the first receiving interval from a base station;
operating in a second operation level when a real-time service is provided from the base station and receiving a VoIP packet every second receiving interval during a talk spurt period in which the VoIP packet of a real-time service is transmitted; and
operating in a first operation level and determining whether the VoIP packet is transmitted every first receiving interval during a silence period in which the VoIP packet of a real-time service is not transmitted.

10. The method of claim 9, further comprising:
driving a first timer when entering from the talk spurt period to the silence period; and
performing a transition from the second operation level to the first operation level when the VoIP packet is not transmitted even though the time determined by the first timer has passed.

11. The method of claim 9, further comprising:
driving a second timer in the silence period; and
performing a transition from the first operation level to the second operation level when the VoIP packet of the real-time service is received before the time determined by the second timer has passed.

12. The method of claim 10, wherein the mobile station manages the first timer or the second timer and performs the level transition according to time determined by the first timer or the second timer regardless of control of the base station.

13. The method of claim 10, wherein the base station manages the first timer or the second timer and controls the level transition by transmitting a message that includes an indicator for indicating the level transition when the time determined by the first timer or the second timer has passed.

14. The method of claim 9, further comprising:
performing a transition to the continuous reception level if the non-real-time service is generated when receiving the VoIP packet every second reception interval in the second operation level; and
performing a transition to the second operation level when the packet data transmission of the non-real-time service is completed in a state in which the mobile station receives the packet data in the continuous reception level and receives the VoIP packet.

15. The method of claim 9, further comprising:
performing a transition to the continuous reception level if the non-real-time service is generated when operating in the first operation level in the silence period in which the VoIP packet is not transmitted;
performing a transition to the first operation level when the packet data transmission of the non-real-time service is completed in a state in which the mobile station receives the packet data in the continuous reception level, and determining whether the VoIP packet is received.

16. The method of claim 14, wherein a first timer for the transition from the continuous reception level to the second operation level and a second timer for the transition from the continuous reception level to the first operation level are set up, and the mobile station performs the level transition according to an implicit process.

17. The method of claim 14, wherein the step of performing the level transition when the non-real-time service is generated comprises:
receiving a message that informs of the generation of the non-real-time service from the base station; and
performing a transition to the continuous reception level according to the message.

18. The method of claim 17, wherein the base station informs the mobile station of the generation of the non-real-time service through a MAC control message or scheduling control information according to the interval of the first operation level or the second operation level that is determined for the real-time service when the packet of the non-real-time service is generated.

19. The method of claim 1, wherein the step of being provided with the information comprises:
negotiating the discontinuous reception operation parameters with the base station when a radio barrier with the base station is set up, added, or cancelled; and
being provided with the negotiated DRX operation parameters through a RRC (radio resource control) message.
